(19) United States
(12) Patent Application Publication
(10) Pub. No.: US 2008/0311358 A1
(43) Pub. Date: Dec. 18, 2008

(54) Fluorine Resin Laminated Substrate

(76) Inventors: Akira Tomii, Ibaraki (JP); Takayoshi Ohno, Ibaraki (JP); Etsuya Taki, Tokyo (JP)

Correspondence Address: CHRISTIE, PARKER & HALE, LLP, PO BOX 7068, PASADENA, CA, 91109-7068, US

(21) Appl. No.: 12/086,039

(22) PCT Filed: Dec. 5, 2006
(86) PCT No.: PCT/JP2006/324615

§ 371 Date: Aug. 14, 2008

(30) Foreign Application Priority Data
Dec. 5, 2005 (JP) 2005-350209

(51) Int. Cl. B32B 3/02

(52) U.S. Cl. 428/201

(57) ABSTRACT

A fluorine resin laminated substrate according to the present invention is a fluorine resin laminated substrate provided with multiple substrates on which circuit patterns are formed, and adhesive layers that adhere the multiple substrates together; wherein, the substrates are composed of a prepreg formed by impregnating a reinforcing fiber sheet with a first fluorine resin mixture, the adhesive layers are composed of a film of a second fluorine resin mixture, and the second fluorine resin mixture is a heat-meltable fluorine resin mixture having a melting point lower than the first fluorine resin mixture.

### TECHNICAL FIELD

The present invention relates to a fluorine resin laminated substrate comprising multiple layers of circuit substrates composed of fluorine resin.

### BACKGROUND ART

Some circuit substrates in the form of electronic circuit substrates and so-called multilayer substrates (laminated substrates) having a multilayer wiring structure use polytetrafluoroethylene (PTFE) for the material of the substrate (see Japanese Unexamined Patent Publication No. 2000-286560). These substrates are formed by forming a prepreg, in which a glass cloth or aramid fiber non-woven fabric is impregnated with a PTFE material, into a sheet and then laminating this sheet to a PTFE film to form the substrate, after which an electrically conductive pattern is formed thereon. A plurality of these substrates are then layered in the state of having an adhesive film composed of tetrafluoroethylene-ethylene copolymer (E/TFE) inserted between each substrate followed by hot pressing to form a multilayer substrate. This multilayer substrate utilizes the properties of a low dielectric constant and dielectric loss tangent of fluorine resin, thereby allowing the obtaining of favorable electrical characteristics and reduction of high frequency loss.

### DISCLOSURE OF THE INVENTION

In a multilayer substrate as described above, PFTE is used for the material of the substrate and heat-meltable E/TFE is used for the adhesive film that adheres the substrates together. The substrates are then laminated by melting the E/TFE by hot pressing to adhere the substrates together.

However, in the case of this multilayer substrate, although the PTFE used for the substrate material has heat resistance, since it does not have adhesion, in the case of laminating the substrates by hot pressing, the substrates are adhered together only by the adhesive strength of the E/TFE. Consequently, the adhesive strength between substrates is weak resulting in the risk of the substrates being easily separated by external stress and the like.

On the other hand, a multilayer substrate has been proposed for the purpose of overcoming the above problems that uses a heat-meltable tetrafluoroethylene-perfluoroalkylvinyl ether copolymer (PFA) instead of PTFE for the material of the substrate, and also uses PFA for the adhesive film used to adhere the substrates together. As a result, since the substrates and adhesive film are composed of the same heat-meltable fluorine resin, in the case of adhering by hot pressing, the resulting multilayer substrate allows the obtaining of powerful adhesive strength. In addition, since PFA can be melted by heating, there are cases in which it is comparatively easy to form it into a substrate as compared with the case of using PTFE.

However, in the case of using PFA for the substrates and adhesive film, although it is possible to obtain powerful adhesive strength, since the melting point of the PFA is the only melting point, when adhering by hot pressing, the PFA within the substrates also ends up melting, thereby making it difficult to laminate the substrates without causing deformation and positional shifting of the substrates.

In consideration of the various problems as described above, an object of the present invention is to provide a fluorine resin laminated substrate that maximally suppresses deformation and positional shifting of substrates while improving adhesive strength.

In order to achieve the aforementioned object, the fluorine resin laminated substrate of the present invention is a fluorine resin laminated substrate provided with multiple substrates on which circuit patterns are formed, and adhesive layers that adhere the multiple substrates together; wherein, the substrates are composed of a prepreg formed by impregnating a reinforcing fiber sheet with a first fluorine resin mixture, the adhesive layers are composed of a film of a second fluorine resin mixture, and the second fluorine resin mixture is a heat-meltable fluorine resin mixture having a melting point lower than the first fluorine resin mixture. As a result, the substrates and the adhesive layers each contain heat-meltable fluorine resin, and the fluorine resin contained in the adhesive layers melts at a lower temperature than the fluorine resin contained in the substrates. Consequently, in the case of adhering the substrates by hot pressing, even if the adhesive layers begin to melt, the substrates do not melt and are able to maintain their shape, thereby making it possible to provide a fluorine resin laminated substrate having powerful adhesive strength while maximizing suppression of deformation and positional shifting of the substrates.

In addition, in the fluorine resin laminated substrate of the present invention, the first fluorine resin mixture comprises a tetrafluoroethylene-perfluoroalkylvinyl ether copolymer (PFA) having a functional group, a liquid crystal polymer resin (LCP) and a tetrafluoroethylene-perfluoroalkylvinyl ether copolymer (PFA) not having a functional group. As a result, the substrates is impregnated with heat-meltable PFA. Consequently, it is possible to have powerful adhesion between the substrates and adhesive layers, while also obtaining substrates having flexibility.

In addition, in the fluorine resin laminated substrate of the present invention, the second fluorine resin mixture is comprised of tetrafluoroethylene-perfluoroalkylvinyl ether copolymer (PFA) having a functional group, liquid polymer resin (LCP) and tetrafluoroethylene-hexafluoropropylene copolymer (FEP) not having a functional group. As a result, FEP having a lower melting point than PFA is contained in the adhesive layers. When laminating the substrates, even if the adhesive layers begin to melt, the PFA melted and impregnated in the substrates does not melt, thereby making it possible to adhere the substrates while suppressing deformation and positional shifting of the substrates. Thus, a fluorine resin laminated substrate can be provided having powerful adhesive strength that maximizes suppression of deformation and positional shifting of the substrates.

### BRIEF DESCRIPTION OF THE DRAWINGS

FIG. 1 is a schematic cross-sectional view of a fluorine resin laminated substrate 1 according to an embodiment of the present invention;

FIG. 2 is a drawing showing the steps for forming a fluorine resin laminated substrate 1;

FIG. 3 is a schematic drawing of a testpiece for investigating deformation and positional shifting of a fluorine resin laminated substrate 1; and

FIG. 4 is a drawing showing the results of testing for a fluorine resin laminated substrate 1.

### BEST MODE FOR CARRYING OUT THE INVENTION

The following provides an explanation of embodiments of the present invention with reference to the drawings. Furthermore, the embodiments explained below do not limit the invention as claimed in the claims, and all combinations of characteristics explained in the embodiments are not necessarily essential for carrying out the present invention.

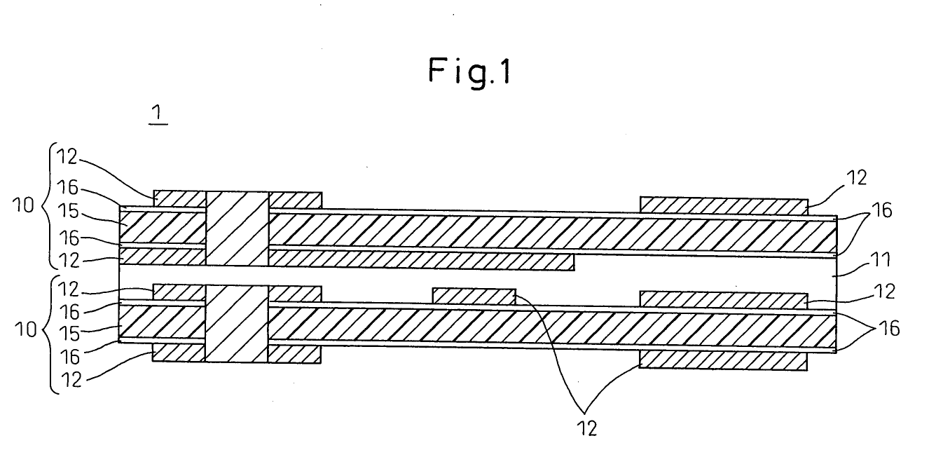

FIG. 1 is a cross-sectional view of a fluorine resin laminated substrate 1 characteristic of an embodiment of the present invention. As shown in FIG. 1, the fluorine resin laminated substrate 1 of the present embodiment is provided with two copper clad laminates (CCL) 10 (substrates), and a fluorine resin adhesive film 11 (adhesive layer), and copper foil circuit patterns 12 are formed on CCL 10. The fluorine resin laminated substrate 1 of the present embodiment is formed by, for example, adhering the CCL 10 (two CCL 10 in the present embodiment) with the fluorine resin adhesive film 11 interposed there between.

The CCL 10 are formed in the form of substrates by forming a substrate fluorine resin mixture (first fluorine resin mixture) into a sheet to produce a substrate fluorine resin mixture sheet 16, and laminating this substrate fluorine resin mixture sheet 16 with a reinforcing fiber sheet 15 such as a glass cloth or aramid fiber non-woven fabric, and copper foil, followed by heat treatment. In the present embodiment, the substrate fluorine resin mixture sheet 16 and the reinforcing fiber sheet 15 produced from glass cloth serving as the reinforcing material are layered, the copper foil 12a is layered thereon followed by heat treatment to melt and impregnate the reinforcing fiber sheet 15 with the substrate fluorine resin mixture sheet 16 and adhere the layered copper foil 12a. This substrate fluorine resin mixture sheet 16 is a fluorine resin mixture containing PFA that is a heat-meltable and adhesive fluorine resin, which is a mixture of PFA having a functional group at 1 to 20 mass %, a liquid crystal polymer (LCP) at 1 to 15 mass % and PFA not having a functional group at 65 to 98 mass %. This substrate fluorine resin mixture is then formed by extrusion into a sheet having a thickness of 10 to 50 μm, and the formed sheet is used as the substrate fluorine resin mixture sheet 16 as previously described in CCL 10 of the present embodiment.

Furthermore, the PFA having a functional group of the present application refers to PFA having a side chain functional group or a functional group bonded to a side chain, and examples of the functional groups include esters, alcohols, acids (including carbonic acid, sulfuric acid and phosphoric acid), salts and halides thereof. Examples of other functional groups include cyanates, carbamates and nitrites. Specific examples of functional groups that can be used include —SO₂F, —CN, —COOH and —CH₂-Z (wherein, Z refers to —OH, —OCN, —O—(CO)—NH₂ or —OP(O) (OH)₂). Preferable examples of functional groups include —SO₂F and —CH₂-Z (wherein, Z represents —OH, —O—(CO)—NH₂ or —OP(O) (OH)₂, while particularly preferable examples include —CH₂-Z in which -Z represents —OH, —O—(CO)—NH₂ or —OP(O) (OH)₂.

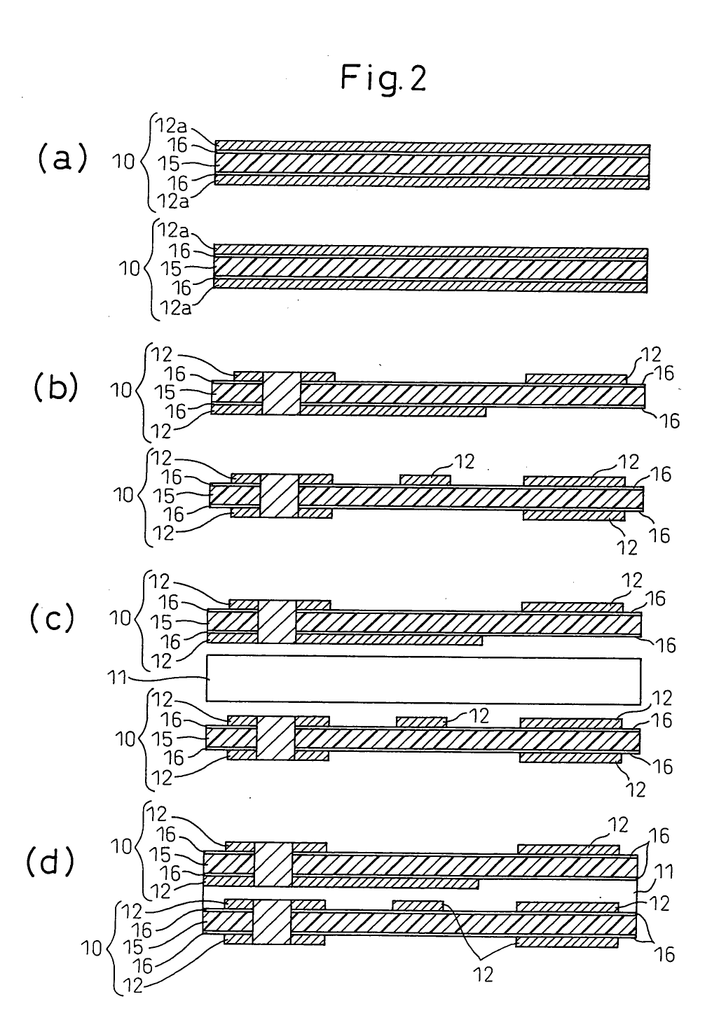

The fluorine resin adhesive film 11 is that in which an adhesive fluorine resin mixture (second fluorine resin mixture) has been formed into a film. This adhesive fluorine resin mixture is a fluorine resin mixture comprised of a heat-meltable and adhesive fluorine resin in the form of tetrafluoroethylene-perfluoroalkylvinyl ether copolymer (PFA), and is formed by extruding a mixture consisting of PFA having a functional group at 0.1 to 10 mass %, LCP at 0.5 to 20 mass % and FEP not having a functional group at 70 to 99.4 mass % into a film having a thickness of 10 to 50 μm. The following provides a detailed explanation of a method for forming the fluorine resin laminated substrate 1 with reference to FIG. 1 and FIG. 2.

FIG. 2 is a drawing showing the steps for forming the fluorine resin laminated substrate 1 of the present embodiment. As shown in FIG. 2(a), the CCL 10 of the fluorine resin laminated substrate 1 are formed by laminating the substrate fluorine resin mixture sheet 16, the reinforcing fiber sheet 15 and the copper foil 12a followed by heat treatment. Furthermore, these CCL 10 may also be formed by laminating the substrate fluorine resin mixture sheet 16 onto both sides of the reinforcing fiber sheet 15 followed by heat treatment to produce a prepreg by melting and impregnating the substrate fluorine resin mixture into the reinforcing fiber sheet 15 followed by adhering the copper foil 12 thereon. In the CCL 10 formed in this manner, etching treatment is then carried out on the copper foil 12a to form a circuit pattern 12 followed by the formation of a through hole as necessary as shown in FIG. 2(b). The CCL 10 are then able to provide an electrical connection between the multiple layers. As a result of then laminating at least two patterned CCL 10 with the fluorine resin adhesive film 11 interposed therebetween and adhering by hot pressing as shown in FIG. 2(c), a multilayered fluorine resin laminated substrate 1 is formed as shown in FIG. 2(d). Furthermore, through holes can also be formed to electrically connect circuit patterns 12 between each layer as necessary.

As a result, the fluorine resin laminated substrate 1 of the present embodiment becomes a flexible multilayer substrate consisting entirely of fluorine in which circuit patterns 12 are laminated with the fluorine resin adhesive film 11 interposed therebetween, and as a result, is a multilayer substrate provided with the properties of fluorine resin of low dielectric constant and low dielectric tangent loss. Since the substrates are formed and laminated only with an adhesive fluorine resin, the adhesion of the copper foil is satisfactory and the fluorine resin laminated substrate 1 of the present invention has powerful adhesive strength.

Furthermore, in the fluorine resin laminated substrate 1 of the present embodiment, although CCL 10 are formed by layering the substrate fluorine resin mixture sheet 16 and the copper foil 12a on a glass cloth in the form of the reinforcing fiber sheet 15 followed by heat treatment, the CCL 10 of the present embodiment are not limited thereto. For example, that which has been laminated by layering multiple prepregs may be used, or the reinforcing fiber sheet 15 may be an aramid fiber non-woven fabric, for example, instead of glass cloth.

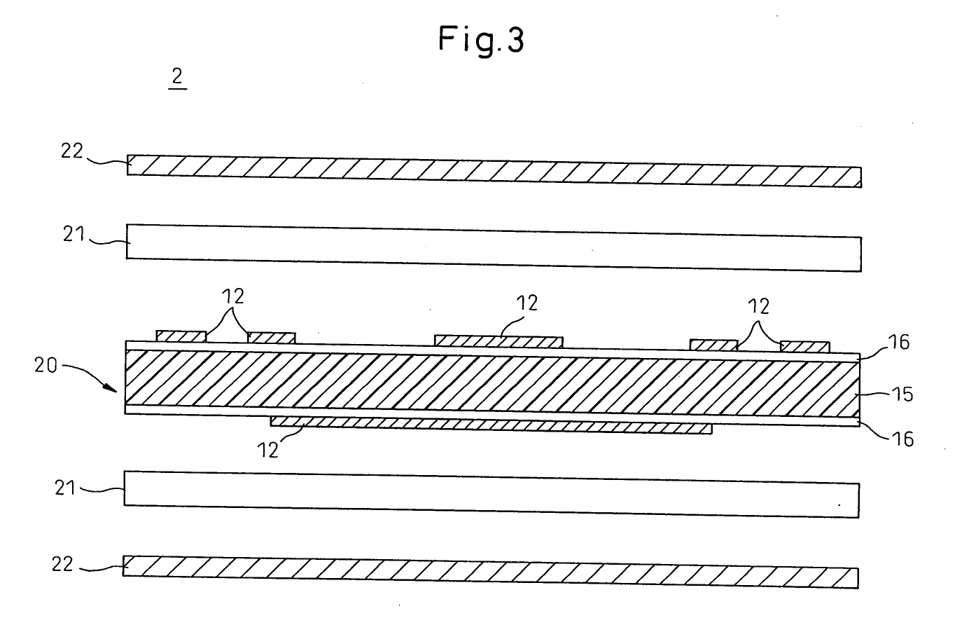

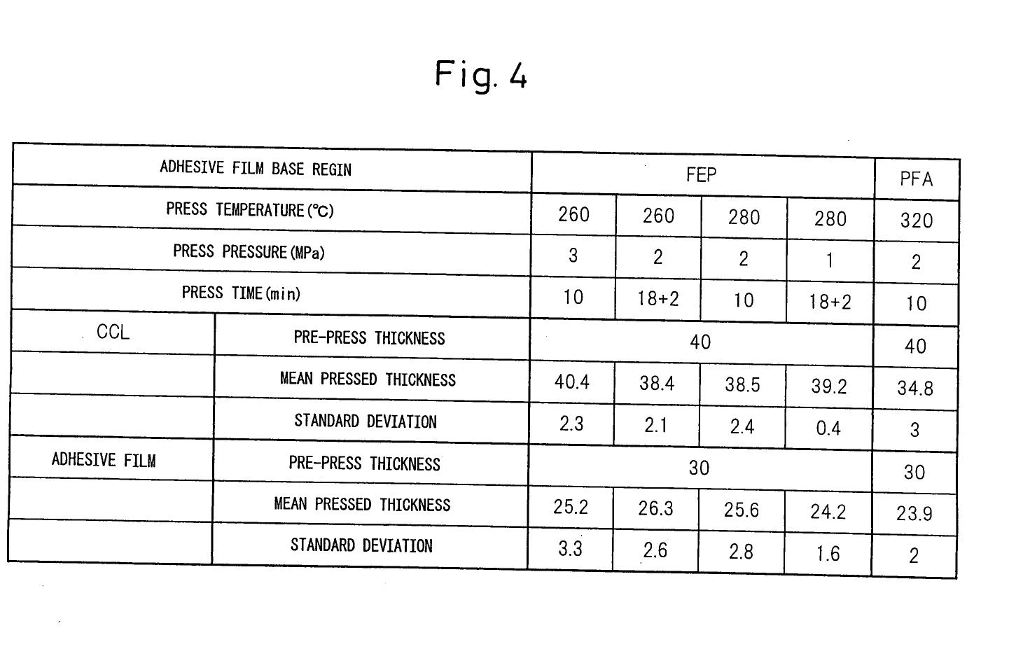

In addition, in the fluorine resin laminated substrate 1 of the present embodiment, since the melting temperature of the fluorine resin adhesive film 11 composed of an adhesive fluorine resin mixture is lower than the melting temperature of the substrate fluorine resin mixture sheet 16 used in CCL 10, when laminating CCL 10 with the fluorine resin adhesive film 11 interposed therebetween, deformation and positional shifting of CCL 10 can be suppressed. The following provides a detailed explanation of a test carried out on this effect of suppressing deformation and positional shifting along with the results of that test using FIGS. 3 and 4.

FIG. 3 is a schematic drawing of a test carried out to investigate deformation and positional shifting of the fluorine resin laminated substrate 1 of the present embodiment, and the test results are shown in the table in FIG. 4. FIG. 3 shows how the testpiece 2 is laminated, which is used in this test, and FIG. 4 shows the conditions of press temperature, press pressure and press time used in this test, along with changes in the thickness of a testpiece 2 when the testpiece 2 was adhered under these conditions.

As shown in FIG. 3, the testpiece 2 used in this test used a test CCL 20 for the base material, had test adhesive films 21 layered thereon above and below, and had test copper foils 22 layered on the test adhesive films 21. Furthermore, the test CCL 20 and the test adhesive films 21 used were of the same materials as the CCL 10 and fluorine resin adhesive film 11 of the present embodiment. In addition, the test CCL 20 used in the testpiece 2 had a thickness of 40 μm, the test adhesive films 21 had a thickness of 30 μm, and the test copper foils 22 had a thickness of 18 μm.

Then, as shown in FIG. 4, fluorine resin laminated substrates are formed from the testpiece 2 by hot pressing under different conditions, and the change in thickness is investigated. In this connection, the test results for the testpiece 2, in which the substrate fluorine resin mixture sheet 16 is used for the test adhesive film 21, are reported as comparison.

As shown in FIG. 4, in the testpiece 2, in which an adhesive fluorine resin mixture is used for the test adhesive films 21, the change in thickness of the test CCL 20 is less than that of the testpiece 2 using the substrate fluorine resin mixture sheet 16 for the test adhesive films 21, and the value for standard deviation is also smaller. This is because, in the case of having used the substrate fluorine resin mixture sheet 16 for the test adhesive films 21, the testpiece 2 cannot be adhered unless the press temperature is raised to the temperature at which the substrate fluorine resin mixture in the test CCL 20 melts when adhering the testpiece 2, and as a result, the substrate fluorine resin mixture inside the test CCL 20 ends up melting. Thus, in the fluorine resin laminated substrate 1 of the present embodiment using an adhesive fluorine resin mixture for the fluorine resin adhesive film 11, deformation and positional shifting of CCL 10 can be suppressed.

In addition, in the case of having used an adhesive fluorine resin mixture for the test adhesive films 21, carrying out pressing at a press temperature of 280° C., press pressure of 1 MPa, preheating time of 18 minutes and press time of 2 minutes yields a lower value for standard deviation than carrying out pressing at a press temperature of 260° C., press pressure of 3 MPa and press time of 10 minutes. On the basis thereof, in the fluorine resin laminated substrate 1 of the present embodiment, changing the press temperature and press time is predicted to be more effective for suppressing deformation and positional shifting of CCL 10 than changing the press pressure.

As has been described above, the fluorine resin laminated substrate 1 of the present embodiment is a fluorine resin laminated substrate 1 provided with a plurality of CCL 10 in which circuit patterns 12 are formed, and a fluorine resin adhesive film 11 for adhering the plurality of CCL 10, wherein the CCL 10 are composed of a prepreg formed by impregnating the reinforcing fiber sheet 15 with the substrate fluorine resin mixture sheet 16, the fluorine resin adhesive film 11 is composed of a film of an adhesive fluorine resin mixture, and the adhesive fluorine resin mixture is a heat-meltable fluorine resin mixture having a melting point lower than that of the substrate fluorine resin mixture of the substrate fluorine resin mixture sheet 16. As a result, both the CCL 10 and the fluorine resin adhesive film 11 respectively contain heat-meltable fluorine resin, and the adhesive fluorine resin mixture contained in the fluorine resin adhesive film 11 melts at a lower temperature than the substrate fluorine resin mixture of the substrate fluorine resin mixture sheet 16 contained in CCL 10. Consequently, in the case of adhering CCL 10 by hot pressing, even if the fluorine resin adhesive film 11 begins to melt, the substrate fluorine resin mixture of CCL 10 does not melt and is able to maintain its shape. Thus, it is possible to provide a fluorine resin laminated substrate 1 having powerful adhesive strength that maximally suppresses deformation and positional shifting of CCL 10.

In addition, in the fluorine resin laminated substrate 1 of the present embodiment, the substrate fluorine resin mixture sheet 16 is comprised of PFA having a functional group, LCP and PFA not having a functional group. As a result, a substrate fluorine resin mixture containing heat-meltable PFA is impregnated in CCL 10. Consequently, powerful adhesion can be generated between CCL 10 and the fluorine resin adhesive film 11, thereby making it possible to obtain a flexible substrate.

In addition, in the fluorine resin laminated substrate of the present embodiment, the adhesive fluorine resin mixture is comprised of PFA having a functional group, LCP and FEP not having a functional group. As a result, an adhesive fluorine resin mixture containing FEP having a lower melting point than the PFA contained in the substrate fluorine resin mixture of the substrate fluorine resin mixture sheet 16 is contained in the fluorine resin adhesive film 11. Consequently, even if the fluorine resin adhesive film 11 begins to melt, the substrate fluorine resin mixture impregnated in CCL 10 does not melt, thereby enabling CCL 10 to be adhered together while suppressing deformation and positional shifting of the substrates. Thus, it is possible to provide a fluorine resin laminated substrate 1 having powerful adhesive strength that maximally suppresses deformation and positional shifting of CCL 10.

### INDUSTRIAL APPLICABILITY

The present invention is applicable to any type of device provided the device is provided with a circuit substrate. For example, the present invention can be applied to electronic devices such as calculators or computers, and can also be applied to mechanical control circuits in which control devices are required to be installed in confined spaces as in automobiles, airplanes and the like.

1. A fluorine resin laminated substrate provided with multiple substrates on which circuit patterns are formed, and adhesive layers that adhere the multiple substrates together; wherein, the substrates are composed of a prepreg formed by impregnating a reinforcing fiber sheet with a first fluorine resin mixture, the adhesive layers are composed of a film of a second fluorine resin mixture, and the second fluorine resin mixture is a heat-meltable fluorine resin mixture having a melting point lower than the first fluorine resin mixture.

2. The fluorine resin laminated substrate according to claim 1, wherein the first fluorine resin mixture is comprised of a tetrafluoroethylene-perfluoroalkylvinyl ether copolymer (PFA) having a functional group, a liquid crystal polymer resin (LCP) and a tetrafluoroethylene-perfluoroalkylvinyl ether copolymer (PFA) not having a functional group.

3. The fluorine resin laminated substrate according to either claim 1 or claim 2, wherein the second fluorine resin mixture is comprised of tetrafluoroethylene-perfluoroalkylvinyl ether copolymer (PFA) having a functional group, a liquid polymer resin (LCP) and a tetrafluoroethylene-hexafluoropropylene copolymer (FEP) not having a functional group.
